(19) United States
(12) Patent Application Publication
(10) Pub. No.: US 2024/0016682 A1
(43) Pub. Date: Jan. 18, 2024

(54) THREE-POINT TRANSFER BELT

(71) Applicant: Paul SWEARINGEN, Marion (IA)

(72) Inventor: Paul SWEARINGEN, Marion (IA)

(21) Appl. No.: 18/351,182

(22) Filed: Jul. 12, 2023

Related U.S. Application Data
(60) Provisional application No. 63/388,482, filed on Jul. 12, 2022.

(51) Int. Cl. A61G 7/10

(52) U.S. Cl. CPC A61G 7/1023

(57) ABSTRACT

The object is a transfer harness device to support and assist in the movement of an unsteady person with comfort to the wearer and ease to the assistive person. The transfer harness device includes a belt with at least three points, each of which are connected to a release latch, with the release latches fitting into corresponding latch housings on a central buckle. The release latches each include an outer mold line and the latch housings each include an internal mold line, which outer mold line corresponds to the internal mold line. The transfer harness device also includes at least one handle to allow the assistive person to lift and support the patient's weight in vicinity of the wearers center of gravity as needed.

This application claims priority to U.S. Provisional Patent Application No. 63/388,482 filed Jul. 12, 2022, the entirety of which is incorporated by reference herein.

### BACKGROUND OF THE INVENTION

This invention concerns an assistive device, a transfer harness used by an assistive person to safely assist with the movement of an unsteady person who may have weakened muscles or are otherwise unsteady or uncoordinated. Such movement of the unsteady person may be movement from a bed to a wheelchair, or assisting the unsteady person with sitting, standing or walking.

Currently, there are gait belts or transfer belts available, which are typically used around the beltline. Such belts are typically made with canvas, nylon, or leather. Gait belts and transfer belts generally consist of one belt of such material, which ends are, buckled together form a loop around the unsteady person. Such buckles may be made of metal or plastic.

Gait belts are placed loosely around the unsteady person's waist and buckled to form a loop. Then, during the movement of the unsteady person, the assistive person holds the belt and assists the unsteady person as they move.

Issues with gait belts arise when they slip upward around the unsteady person's ribs, breasts and sometimes up to the underarms of the wearer. With differing body types and variations in body weight, gait belts tend to ride up on the wearer's side, creating discomfort and making it difficult for the assistive person to grip or hold the gait belt adequately to assist the wearer.

### SUMMARY OF THE INVENTION

The object is a transfer harness device to support and assist in the movement of an unsteady person with comfort to the wearer and ease to the assistive person. The transfer harness device includes a three-point harness system, with a belt around the wearer's waist and a perineum belt between the wearer's legs, which come together in a three-point buckle. The belt around the wearer's waist includes lifting handles, which allow the assistive person to lift and support the patient's weight in vicinity of the wearers center of gravity (“CG”) as needed.

### BRIEF DESCRIPTION OF THE DRAWINGS

FIG. 1—Three dimensional view of transfer harness device

FIG. 2—Overhead view of transfer harness device

FIG. 3—Front view of transfer harness device

FIG. 4—Three dimensional view of the buckle

FIG. 5—Top view of the buckle

FIG. 6—Side view of the buckle

FIG. 7—Cut away view of the buckle

FIG. 8—Bottom view of the buckle

FIG. 9—Cut away view of the buckle

FIG. 10—Cut away view of the buckle base showing the wedge ramp

FIG. 11—Three dimensional view of the release flange

FIG. 12—Top view of the release flange

FIG. 13—Bottom view of the release flange

FIG. 14—Three dimensional view of the lift handle

FIG. 15—Front view of the lift handle

FIG. 16—Exploded view of the buckle and release flanges

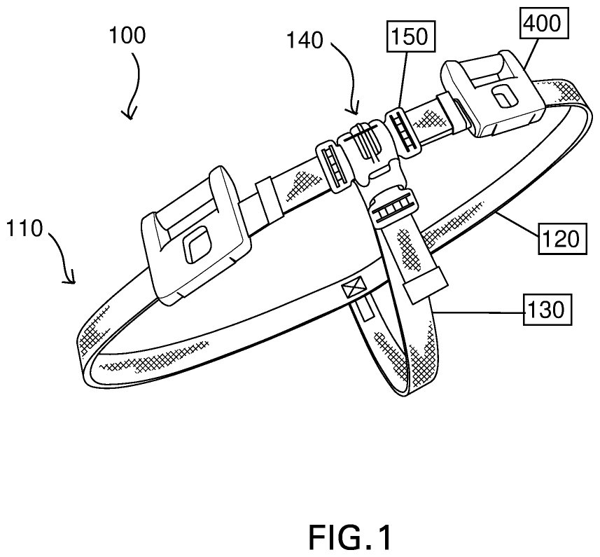

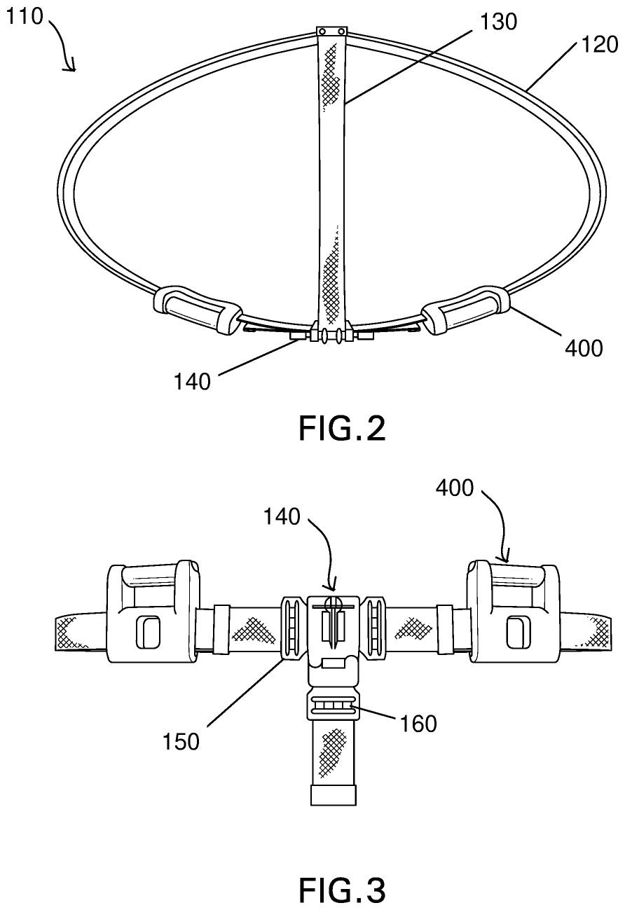

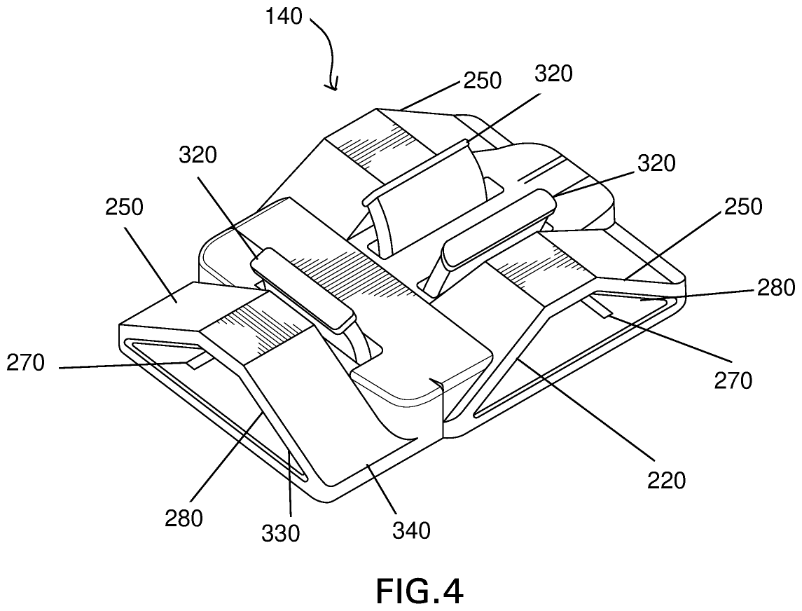

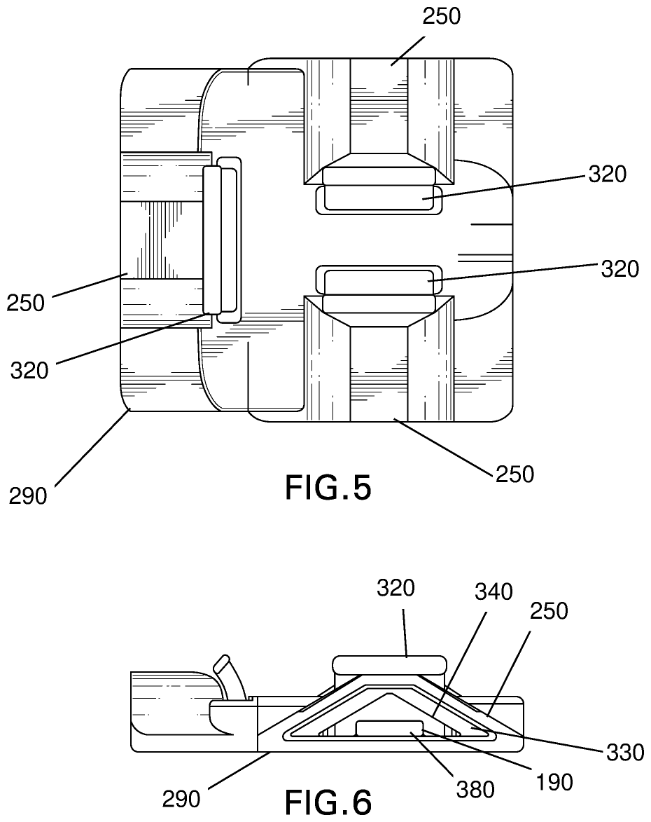

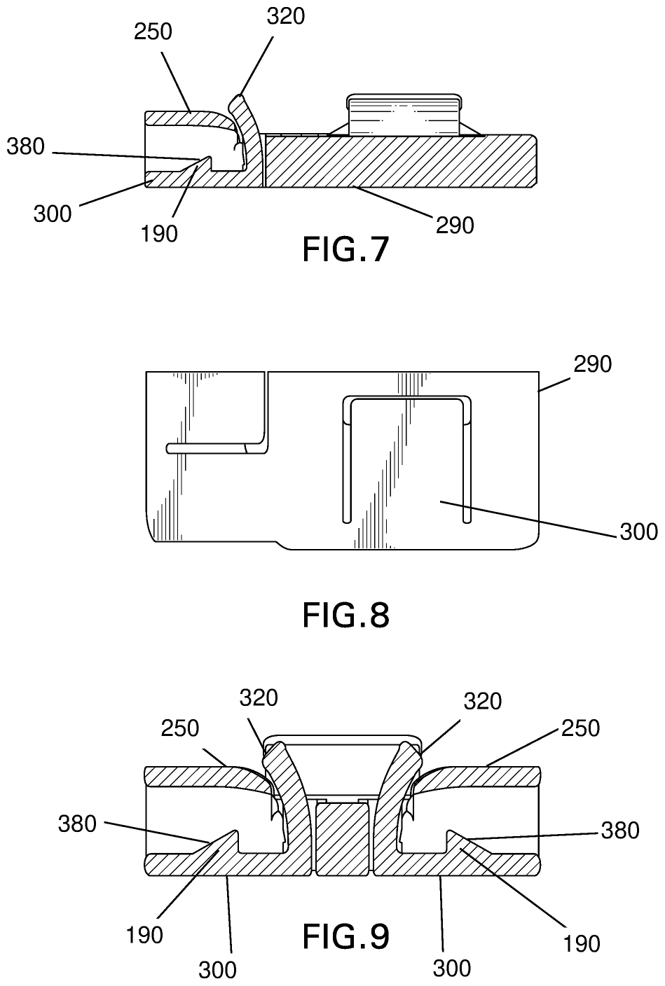

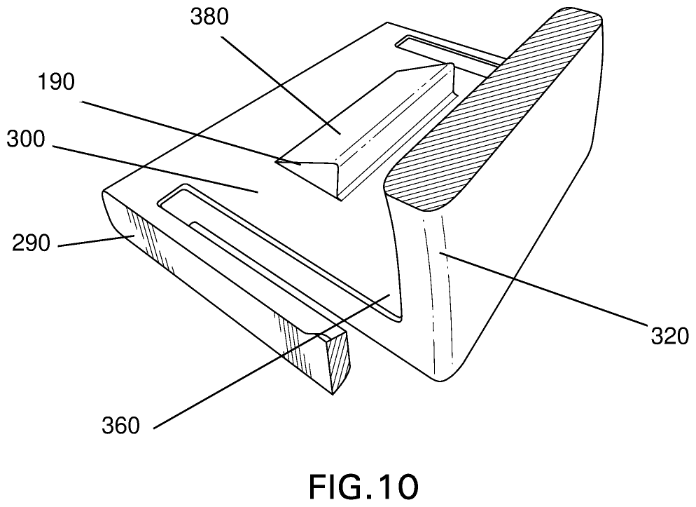

### DETAILED DESCRIPTION

The transfer harness 100 is used in place of a transfer belt or gait belt to support and assist in the movement of an unsteady person with comfort to the wearer and ease to the assistive person. It prevents falls and other embarrassing situations safely and puts an end to grabbing an unsteady person painfully by the arm or the seat of the pants. The transfer harness 100 may be used to assist a patient transfer, i.e. from a bed to a wheelchair or vehicle, to assist a patient to stand up and walk from one place to another, to reduce the risk of patient falls and injuries during movement, and to reduce the risk of sustaining a back injury of caregiver while assisting a patient.

The transfer harness 100 includes a three-point belt 110, including a waste belt 120 used around the wearer's waist and a perineum belt 130 between the wearer's legs. In one embodiment, the three-point belt 110 is made of canvas, nylon, leather, or a woven material. The three-point belt 110 forms a “T”, with the perineum belt 130 located and fixed on the waist belt 120. The perineum belt 130 is located on the waist belt 120 at the CG of the unsteady person, allowing the assistive person a reliable means to lift and translate a patient's load because of stability. In one embodiment, the waste belt 120 measures between 44 to 60 inches and the perineum belt 130 may measure between 22 and 42.5 inches. In one embodiment, the three-point belt 110 is constructed of conventional 2 in. wide, strong nylon webbing, sufficient to carry 450 to 600 lbs. tensile strength. The three-point belt 110 may be washable. The three-point belt 110 may be treated with an antimicrobial material to inhibit growth of bacteria. The three-point belt 110 may include end tips made of chrome metal or other such material to prevent belt flailing and to assist in ease of attachment to the release latches 150. In one embodiment, the transfer harness includes a belt which is more than three points, which has four or more points to wrap around the waste and legs. For a transfer harness with a belt with more than three points, the transfer harness includes a buckle with a corresponding number of points for receiving a corresponding number of release latches.

The transfer harness 110 further includes a release latch 150 which is a quick release latch at each of the ends of the waist belt 120 and perineum belt 130. When pressed into the buckle 140, the release latches 150 provide the three-way load structure to handle the patient's weight and to steady the patients transfer. Features of the release latch 150 include a web attach structure 160 and the self-centering pyramid 170.

Each release latch 150 includes two web attach structures 160. The two web attach structures 160 are two parallel web belt attachment features, one with locking teeth 180 to secure the belt in the desired position.

In one embodiment, the release latch 150 is rated at a lower tensional strength than the rest of the transfer harness 100 so that the release latch 150 will fail prior to the failure of the buckle 140 or other parts of the transfer harness 100. In one embodiment the other components of the transfer harness 100 are rated at 450 lbs. tensional strength. In another embodiment the components of the transfer harness 100 are rated at 600 lbs. Specifically, in one embodiment, the web attach structures 160 of the release latch 150 are de-rated to a lower load capability. In one embodiment the web attach structures 160 have a load capacity of 350 lbs, in which case the web attachment structures 160 will deform prior to a structural failure within the other components of the transfer harness 100. The release latch 150 is easier to inspect and replace than other components of the transfer harness 100.

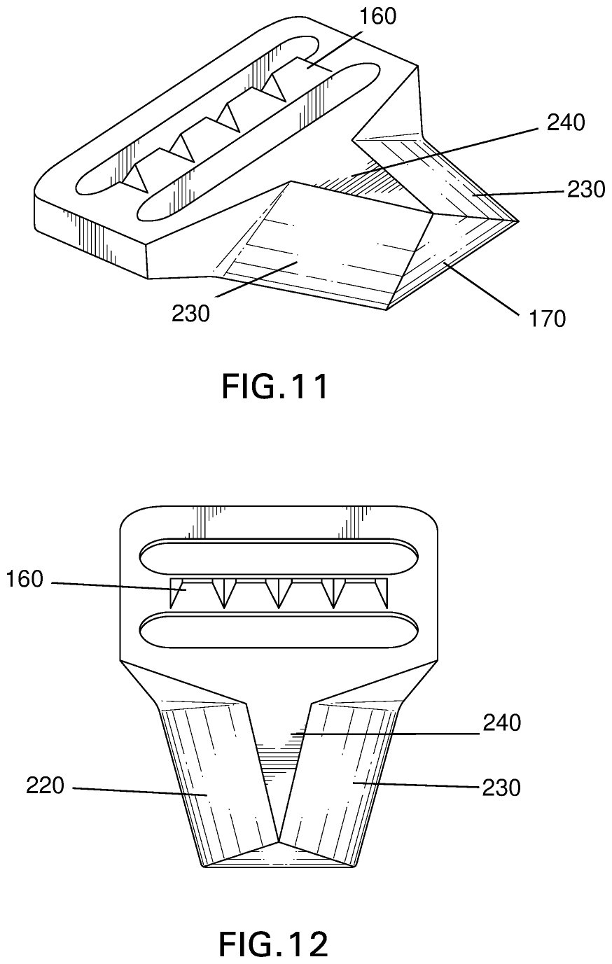

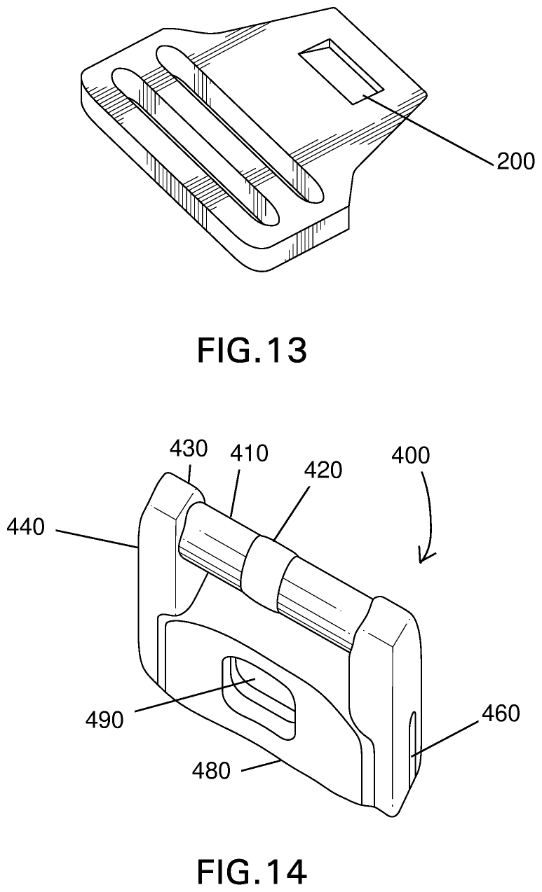

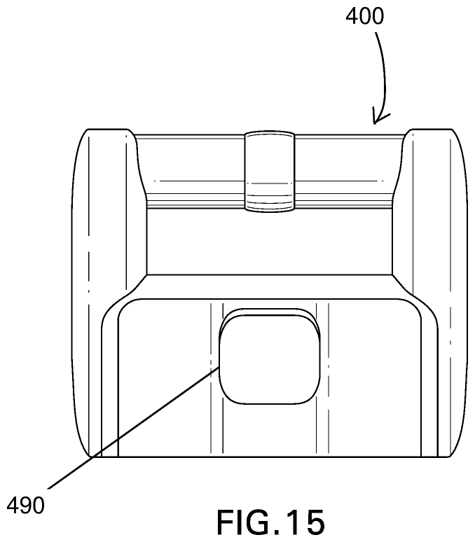

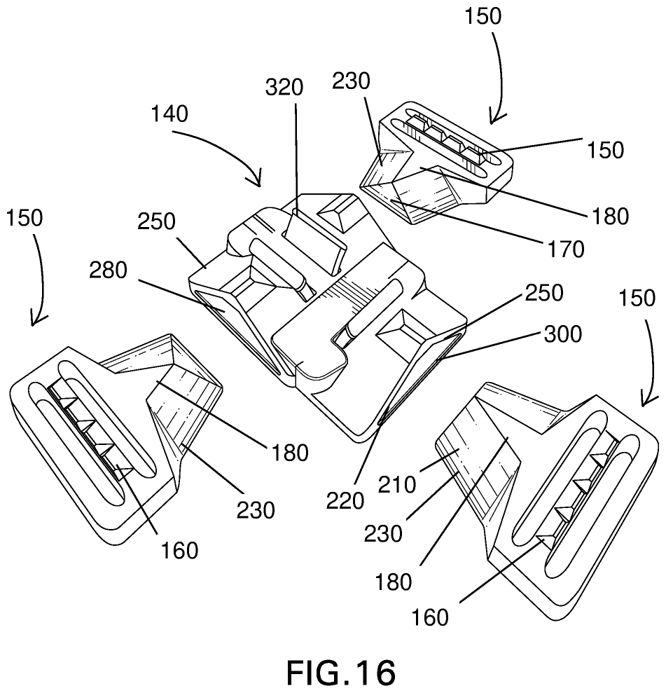

Each release latch 150 also includes a triangular structure 180 which is bi-tapered. The triangular structure 180 provides self-centering, end-point definition. The release latch 150 includes the wedge ramp 190 receiving cavity 200. Relative to cross sections of the release latch 150, the latch outer mold line (“OML”) 210 forms the structural contours of the buckle 140 internal mold lines (“IML”) 220. As shown in FIG. 11, in one embodiment, the release latch 150 tapers from 50 mm to 33 mm at a constant height of 9.25 mm. In a further embodiment, the release latch 150 is triangular, with two adjoining sloped sides 230, which are sloped at 24.5 degrees from horizontal. In one embodiment, the two sloping side surfaces intersect 230, forming a roof triangle 240, measuring 17.16 mm×23 mm. This roof triangle 240 geometry is replicated within the buckle 140, to form the buckle ceiling 250. In one embodiment, the material for the release latch 150 is plastic, nylon, PLA, or other such material rated in shear to 600 lbs.

The transfer harness 100 further includes a three-point buckle 140. The three-point buckle 140 includes three latch housings 280, each within a self-centering retainer 270 to receive the corresponding release latch 150. In one embodiment, the three-point buckle 140 measures 101 mm high by 68 mm wide by 17 mm thick.

The three-point buckle 140 includes a three latch housings 280 formed in a “T”. Each of the latch housings 280 includes one or more of a buckle base 290, buckle tab 300, wedge ramp 190, buckle ceiling 250, release flange 320, and pivotal compliant mechanism 360 structures. The buckle 140 includes a release flange 320 behind each latch housing 280. The release flange 320 may include a 3 mm land so fingers can easily locate the release flange 320. As you move release flange 320, the pivotal compliant mechanism 360 pivots the buckle tab 300 and deforms the wedge ramp 190. The release flange 320 may be engaged to release the release latch 150 from the buckle 140 with just one hand. This is advantageous because it leaves the other hand free for the user to support the wearer of the harness 100.

The three-point buckle 140 may be formed around its flat buckle base 290. The buckle base 290 may be between 2 mm to 4 mm thick and between 64 mm to 72 mm wide. In one embodiment the buckle base is 68 mm wide and 3 mm thick. The material for the three-point buckle 140 may be plastic, nylon, PLA, or other such material.

In one embodiment, the buckle base 290 includes a buckle tab 300 measuring 29 mm wide by 24 mm long. In a further embodiment, the buckle tab 300 includes a triangular wedge ramp 190, which may measure 18.25 mm wide by 8 mm long and 2.35 mm in height and may form an 18-degree triangular ramp. The location of the wedge ramp 190 is equal to but opposite a respective corresponding wedge ramp receiving cavity 200 contained within release latch 150 when fully inserted into the buckle 140. In that the wedge ramp 190 and buckle tab 300 form the structural feature of the buckle assembly 140, it may be rated the same as the transition belt, 600 pounds tension.

In one embodiment, the buckle ceiling 250 comprises a 4 mm thick, roof structure. The buckle ceiling 250 structure mates with the release latch 150 and an internal surface 330 of the buckle ceiling 250 is equal to and opposite in shape as the release latch 150. In one embodiment, the buckle ceiling 250 is sloped at 24.5 degrees from a base 340 of the buckle ceiling 250, each side forming a ceiling measuring 25 mm long×16.28 mm wide at a buckle face 350. The buckle ceiling 250 provides the resisting load path to take out the forces created by the plastic deformation features of the three-point buckle 150.

The three-point buckle 150 includes a release flange 320. Forming the human interface to the buckle tab 300 is the release flange 320. The release flange 320 may be 3.8 mm thick, 28.29 mm wide structure formed on a 17.5 mm radius at 37 degrees from the buckle base 290. When pressed and rotated into the three-point buckle 150, the release flange 320 pivots the buckle tab 300 around the plastic deformation features of the buckle tab 300.

The buckle base 290 and buckle tab 300 may include a mechanism called a compliant mechanism pivot 360. The compliant mechanism pivot 360 transfers and transforms motion of the release latch 150. In one embodiment, two compliant mechanism pivots 360 include respective flexible cross-sections 370 and may use deflection of their respective flexible cross-sections 370 using plastic deformation to rotate. Upon entry of the release latch 150, the two flexible-cross sections 370 are twisted and build energy to return the buckle tab 300 to its original state, which is flat. The release latch 150, when entering the confines of the three-point buckle 140 may provide the force upon the wedge ramp 190 to deflect and pivot the buckle tab 300, until a point where the wedge ramp receiving cavity 200 within the buckle tab 300 receives and mates with the wedge ramp 190. At this point, the buckle tab 300 has rotated and now returns to its original flat state and now, that portion of the three-point buckle 140 is “latched”, at which time an audible “click” can be heard. Similarly, in one embodiment an audible frictional noise of the release latch 150 coming out of the latch housing 280 is heard when the buckle 140 releases the release latch 150. Such auditory cues tell the user that the release latch 150 is latched or removed from the buckle 140 without viewing the buckle 140. The joining of the 1-degree wedge ramp face 380 and the −1 degree vertical cavity face 390 within the self-centering pyramid 170 forms the “latched” condition. The more load applied to the latched condition, the tighter the adjoining latching faces of the latch “OML” 210 and buckle “IML” 220 become. To unlatch, with load removed from three-point belt 110, the buckle tab 300 is pivoted by force on the release flange 320, thus allowing the male triangular wedge ramp 190 to exit from the release latch 150 and release the release latch 150 to exit the three-point buckle 140.

The transfer harness 100 further includes at least one handle 400 configured on the waist belt 120 on either side of the perineum belt 130. The at least one handle 400 may be a lift handle or a guide. The at least one handle 400 may be primarily rated at 350 lbs. The at least one handle 400 slides on the three-point belt 110 to wherever point it is necessary to lift or guide. The at least one handle 400 may include two or more handles 400, which may be both moved to the rear of the three-point belt 110 for lifting with two hands or may be moved to the side and front of the three-point belt 110 for allowing the caregiver any angle and either side for physical therapy, ambulation or transfers, thus reducing the risk of caregiver injury, and providing greater safety to the patient. The at least one handle 400 may measure 149 mm wide×116 mm tall×33.95 mm thick. The at least one handle 400 may further comprise a lifting beam 410 which may be 89 mm wide, and may provide a full five finger, 89 mm wide×23 mm diameter beam 410, which design may include a stress riser egg 420 at the center of the beam 410 to flow the loads of lifting back out to an end interface 430 of the handle 400 with the lifting beams 410. The beam 410 of the at least one handle 400 may be located 28 mm from the body of the at least one handle 400, a sufficient distance to get fingers and rings around the lifting beam 410. The at least one handle 400 may further comprise a lifting column 440 which may be 30 mm×30 mm, and may include two lifting columns 440 which are 115 mm high×30 mm highly rounded cross section lifting columns 440 form an end vertical structure of the handle 400.

The handle 400 may also include at its center a web surround structure 450 that acts as the central load-carrying member of the handle 400. The three-point belt 110 is enters a first end 450 of the handle 400 and exits a second end 460 of the handle 400. The web surround structure 450 may measure 89 mm width×64 mm high. The web surround structure 450 may merge into the lifting columns 440 to transfer the load from the three-point belt 110 to the lifting beam 410. The center web surround structure 450 may include a web belt containment groove 470, wherein the three-point belt 110 is contained within a 55.79 mm high×6.55 mm wide horizontal web belt containment groove 470 within the bottom of the web surround structure 450. The weight of the patient is distributed over the web surround structure below the web belt containment groove 470 and transferred up through the two lifting columns 440 and into the lifting beam 410.

The web surround structure 450 may include a conformal body contour 480 at the inside surface of the web surround structure 450, which conformal body contour 480 is contoured with a radius of 300 mm to 350 mm to accommodate the patients waist profile.

The web surround structure 450 may further include a web cutout window 490, which is contained within the center-line of the web surround structure 450. Measuring 41 mm wide×37 mm high, the web cutout window 490 allows a means to transport the three-point belt 110 through the handle 400 structure in addition to the aesthetics of viewing the three-point belt 110, once configured.

The transfer harness 100 may further comprise a disposable sleeve 500 for use as a protective barrier over the perineum belt 130. The disposable sleeve 500 may be a 1.5 mil Polyethylene tube, measuring 3 in. (76.2 mm) in diameter×length of the perineum belt. The disposable sleeve 530 may easily slip over the release latch 150 and the perineum belt 130 not only to prevent the growth of odor-causing bacteria, but disposed of after use.

The transfer harness 100 may further comprise color enhancements in the form of color-coded release latches 150 and adjoining colors on the buckle 140. This aids in the caregiver orientating and buckling the appropriate components when the object is being placed initially on the patient. Using the convention of position colors of GREEN for right, RED for left, and WHITE for rear, the feature of color can help with the experience of placing the transfer harness 100 on the patient. Formed separately, the release latches 150 may be manufactured in colors of green, red and the conventional white.

The transfer harness 100 may further comprise a tactile feel button 550. Respectively, the buckle 140 would contain color appropriate locator 550 shaped in the fashion of a 15 mm locator 550, raised from the surface of the buckle 140 by 3 mm. With this locator 550 feature also, it aids in a dark light situation where, like braille, the locator 550 helps find the release flange 320 of the buckle 140. In one embodiment, each of the buckle latch housing 280 and the corresponding release latch 150 have the same color, which is different than the other buckle latch housings 280 and corresponding release latches 150 for each. In a further embodiment, one set of corresponding buckle latch housing 280 and release latch 150 have red locators and another set of corresponding buckle latch housing 280 and release latch 150 have green locators, and the last set of corresponding buckle latch housing 280 and release latch 150 have white locators. Such color coordination allows for the corresponding release latch 150 and buckle housing 280 to be paired quickly.

What is claimed is:

1. A transfer harness comprising:
a three-point belt including:
a waist belt with two ends;
a perineum belt with a first end and a second end; and
wherein the first end of the perineum belt intersects and is attached to the waist belt at a location between the two ends of the waist belt;
three release latches, wherein one of the three release latches is attached at each of the two ends of the waist belt and at the second end of the perineum belt;
a three-point buckle including three latch housings, wherein each latch housing receives one of the three release latches; and
at least one handle attached to the waist belt.

2. The transfer harness of claim 1, wherein at least one of the three release latches includes a web surround structure with locking teeth and a self-centering pyramid.

3. The transfer harness of claim 1, wherein at least one of the three release latches is rated with lower tensional strength than the rest of the transfer harness.

4. The transfer harness of claim 1, wherein at least one of the three release latches includes:
a triangular structure, wherein the triangular structure is bi-tapered, and a roof triangle.

5. The transfer harness of claim 1, wherein at least one of the three release latches includes a wedge ramp receiving cavity, wherein at least one of the three latch housings of the three-point buckle includes a wedge ramp, and wherein the wedge ramp fits in the wedge ramp receiving cavity.

6. The transfer harness of claim 1, wherein each latch housing includes a self-centering retainer.

7. The transfer harness of claim 1, wherein the three-point buckle includes at least one of a buckle base, buckle tab, wedge ramp, buckle ceiling, release flange, and a plastic deforming feature.

8. The transfer harness of claim 1, wherein the three-point buckle includes a buckle base which is between 2.0 mm and 4.0 mm thick and which is between 64 mm to 72 mm wide.

9. The transfer harness of claim 1, wherein the three-point buckle includes a buckle tab and wherein the buckle tab is between 21.35 mm and 29.35 mm long and between 24.3 mm and 32.3 mm wide and between 2 mm and 4 mm thick.

10. The transfer harness of claim 1, wherein the three-point buckle includes a buckle base with a buckle tab which includes a triangular wedge ramp inclining at between 14 and 22 degrees.

11. The transfer harness of claim 1, further comprising a release flange located on the three-point buckle, wherein the three-point buckle includes a buckle tab, and wherein the release flange pivots the buckle tab to dislocate at least one of the three release latches from the three-point buckle.

12. The transfer harness of claim 1, wherein each of the latch housings include an internal mold line and the three release latches each include an outer mold line, and wherein the internal mold line and the outer mold line meet.

13. A transfer harness comprising:
a harness including comprising at least three ends;
a release latch at each of the at least three ends wherein each release hatch includes a wedge ramp receiving cavity and a self-centering pyramid;
a buckle including a latch housing for each of the at least three ends;
wherein each latch housing includes a wedge ramp, and an internal surface of a buckle ceiling; and
wherein each of the release latches click locks with the buckle when the self-centering pyramid meets the internal surface of the buckle ceiling and the wedge ramp fits into the wedge ramp receiving cavity.

14. The transfer harness of claim 13, wherein:
the buckle further comprises a release flange and a compliant mechanism pivot;
the latch housing includes a buckle tab on which the wedge ramp is located; and
the buckle tab is connected to the release flange via the compliant mechanism pivot such that movement of the release flange is transferred via the compliant mechanism pivot to deform the buckle tab.
